(19) United States
(12) Patent Application Publication
(10) Pub. No.: US 2010/0065781 A1
(43) Pub. Date: Mar. 18, 2010

(54) Device for Gasification of Biomass and Organic Waste Under High Temperature and with an External Energy Supply in Order to Generate a High-Quality Synthetic Gas

(75) Inventor: Meryl BROTHIER, Aix en Provence (FR)

Correspondence Address: Nixon Peabody LLP, P.O. Box 60610, Palo Alto, CA, 94306, US

(73) Assignees: COMMISSARIAT A L'ENERGIE ATOMIQUE, Paris (FR); EUROPLASAMA, Morcenx (FR)

(21) Appl. No.: 12/083,427

(22) PCT Filed: Oct. 12, 2006
(86) PCT No.: PCT/EP2006/067351

§ 371 Date: Apr. 11, 2008

(30) Foreign Application Priority Data
Oct. 14, 2005 (FR) 0553128

(51) Int. Cl. B01J 19/08; C01B 3/34

(52) U.S. Cl. 252/373; 422/186

(57) ABSTRACT

The invention relates to a device for gasification of material comprising:
a chamber (1) for mixing a plasma and material to be treated, comprising openings (12, 12′, 13, 13′, 14) for positioning means for injecting a flow of said material and for positioning at least one plasma source, and forming a zone (300) for a homogenous mixture of a flow of said material and at least one plasma jet (200, 200′)
a zone for reaction (5a, 5b), of a mixture of said material and the plasma, in communication with an opening of the chamber and extending axially.

### TECHNICAL FIELD AND PRIOR ART

This invention relates to a device for gasification of biomass, pretreated or not, and/or of solid and/or liquid and/or gaseous organic waste with a view to the production of a high-quality synthetic gas, i.e. with very few impurities and rich in hydrogen and carbon monoxide.

Numerous processes involve biomass and organic waste energy conversion in order to generate a convertible gas. This gas can be used to feed a downstream co-generation process or, if the quality of the gas allows it, to serve as a reactant in a chemical process such as, for example, fuel synthesis (of the Fischer-Tropsch type, in particular).

A number of publications describe various biomass gasification techniques for generating a synthetic gas.

Thus, co- or counter-current and pressurized or non-pressurized fixed bed reactors are known. The following patents can be mentioned as examples: U.S. Pat. No. 4,643,109, U.S. Pat. No. 5,645,615 or U.S. Pat. No. 4,187,672. A certain number of alternatives have in particular been envisaged for increasing the conversion level of the carbon charge implemented in this type of device. However, these techniques do not make it possible to optimize the conversion, and in particular to minimize the formation of methane and heavier organic species such as tars.

Another example is provided in document GB 2160219.

This document describes a gasification process implementing a plasma torch in order to produce a hot gas composed primarily of CO2 and H2 from carbon material, such as coal or peat. This carbon material is introduced in powdered form, at the same time as an oxidizing agent, into a combustion chamber. The carbon material is introduced into the gasification chamber, either by an annular conduit arranged around the plasma generator, which corresponds to a mode of injection of the charge concentric to the plasma flow, or by a sprayer, which corresponds to a lateral injection mode of the charge with respect to the plasma flow. In this document, the gasification chamber has a cylindrical shape.

A tank filled with a solid carbon material bed has an axis nearly perpendicular to that of the gasification chamber. It is intended to reduce the CO2 and H2O content of the gaseous mixture coming from the gasification chamber.

A disadvantage of the device presented in patent GB 2 160 219 is the significant thermal inertia of the device associated with the process. The entire device must be insulated with large amounts of refractory material, which leads to significant additional costs, and increases in the size of the device. This device also has a significant inertia, resulting in a separation between the great flexibility of the plasma torch and the very significant inertia of the reaction zones.

Moreover, with this type of cylindrical shape of the gasification chamber, the mixture between the plasma flow and the material is very limited, as the flow of plasma with a very high viscosity does not penetrate or barely penetrates the injected material. Such a mixture is all the more imperfect insofar as the central axial part of the plasma flow, with a very high temperature (and a higher temperature than the average temperature of the plasma, i.e. much higher than 5000 K in non-transferred arc plasma torches, which result is caused by the heating of the gas with an electric arc centered inside the torch) and therefore with a very high viscosity, remains, with previously known gasification chamber shapes, “inaccessible” to the injected material.

Furthermore, the extrapolation of one or the other of the reactor types described or mentioned above is limited beyond a certain size and therefore a certain treatment capacity. In particular, the occurrence of hot spots or preferred passages for the gases constitute detrimental limitations beyond a certain size, which is dependent on numerous parameters, and in particular the nature of the charge to be treated.

Fluidized bed reactors, pressurized or not, integrating a recirculation loop or not, are also known. As an example, document US 2004/0045279 presents such a system by making the distinction between the gasification zone and the combustion zone, where a part of the carbon charge and/or of the gas generated in the gasification is used to supply the energy needed for the gasification conversion, which is endothermic.

Most processes responding to this type of technology have temperature limitations (˜1000° C.) related to the possible agglomeration of the bed, in particular, according to the ash content of the materials to be gasified. Another problem is due to the erosion of the system for recirculation of the heat carrier fluid or the fluidizing agent. These processes thus suffer from pressure limitations, due to their biomass supply system. Moreover, their limited operating temperature is not favorable for the optimal generation of hydrogen and carbon monoxide. It would be necessary to further increase the temperature in order to promote the formation of hydrogen and carbon monoxide. Certain other techniques have been proposed, such as those described in the U.S. Pat. No. 6,808,543, but they still remain relatively limited in terms of efficacy. Furthermore, in order still to control the ash agglomeration phenomena making fluidization of the charge to be treated impossible, this type of reactor operates at a moderate temperature, namely at temperatures below the melting temperature of ash. This process condition on the temperature in fact results in a limited quality of the synthetic gas generated by this type of reactor.

Reactors with a reaction medium primarily constituted by a salt or molten metal bath are also known.

These devices, such as the one described in U.S. Pat. No. 6,110,239, make use of the ability of such baths to convert a carbon charge into gases primarily composed of carbon monoxide and hydrogen. Nevertheless, this type of process requires the implementation of refractory materials that are often difficult to manage and expensive. Moreover, these types of reactors have a thermal inertia both on start-up and on stopping, which results in usage precautions that are sometimes very detrimental to the use of the process.

Pressure flow reactors, such as the ones described in U.S. Pat. No. 5,620,487 and U.S. Pat. No. 4,680,035 have the benefit of providing solutions that overcome the limitations of use of fixed and fluidized bed reactors. These devices generally require a very good control of the preparation of the charge to be treated (such as the particle size of the incoming material for solids), so as to ensure a sufficient conversion rate when it goes into the gasification reactor. Specific attention must also be given to the management and control of the temperature in the reactor, and therefore to the choice of refractory materials.

Documents U.S. Pat. No. 5,968,212 or DE 4446803 describe techniques that make it possible to manage dual-constituent refractory zones and cooled zones in order to take into account the thermal constraints.

Aside from this differentiation between technologies, the known processes can be classified into two main categories, namely autothermal devices (i.e. those using some of the heating power of the biomass and/or organic waste in order to ensure their conversion, which is endothermic) and so-called allothermal processes (i.e. defined here as processes that use energy outside the system constituted by the biomass in order to ensure the conversion).

Allothermal processes make it possible to increase the production of carbon monoxide and hydrogen.

So-called allothermal gasification processes can use either a fuel such as natural gas or electricity.

If it is more appropriate to use, at least in part, electricity as the energy source (aside from the cost factor, the minimization of greenhouse gas emissions can be a determining factor), two heating tools can in particular be envisaged, namely:
the electric arc, and
the plasma torch, with a transferred or non-transferred arc.

Thus, a certain number of devices based on the use of these heating tools have been proposed. As examples, U.S. Pat. No. 6,173,002 and U.S. Pat. No. 5,544,597 can be cited respectively for the electric arc and the plasma torch.

One of the major disadvantages of these devices is the persistence of a mediocre gas quality at the outlet of the gasification reactor, at the very lest unsatisfactory for supplying a chemical process using the synthetic gas as an actual reactant. This limitation is due primarily to the difficulty of ensuring a satisfactory contact of the biomass and/or the organic waste with the plasma medium generated at the level of the arc or by the torch.

More specifically, this contact does not involve the entire flow to be converted and does not constitute a sufficient mixture with the plasma gas medium in order to be fully effective.

All of the existing technologies involve a certain number of constraints with regard to their use and/or the limitation of their potentiality.

Synthetically, for each of the devices currently known, at least one, and usually more, of the following problems are encountered:
low material yield (hydrogen and carbon monoxide),
the need to use an expensive reactant such as oxygen in order to prevent any dilution (nitrogen) of the synthetic gas produced,
the substantial presence of by-products from decomposition of the biomass or the organic waste in the synthetic gas generated (tars, etc.). The quality of this gaseous mixture may then be too poor for use as a synthetic reactant for a downstream chemical process (such as, for example the Fischer-Tropsch process),
little latitude with regard to the control of the H2/CO ratio,
difficult implementation, in particular in starting and stopping phases,
possible pollution of the synthetic gas by the refractory material used (wear),
complex control,
large amount of refractory element needed to protect the gasification reactor,
constraints related to the choice of the refractory material in order to achieve a satisfactory lifetime/cost ratio, which choice is often dependent on the ash composition and the reactor control mode (frequency of thermal cycles),
difficulty of to work under pressure, and high reaction medium volume needed for the conversion, which leads to detrimental reactor sizes (in terms of heat balance and/or amount of refractory material necessary for packing of the reactor),
and, possibly, little flexibility for converting a condensed phase (solid or liquid) as well as a gas (which may potentially result from a pretreatment of the biomass and/or organic waste).

### DESCRIPTION OF THE INVENTION

The invention proposes a device making it possible to overcome all or some of the problems encountered in the devices of the prior art.

According to a first aspect of the invention, it relates to a device for gasification, by thermal plasma, of material in order to generate a high-quality synthetic gas, comprising a mixing chamber or means enabling a homogeneous mixture of at least one plasma jet with the charge to be treated. In order to take into account the difficulty of producing a plasma/material mixture (in fact, in particular, the high viscosity of the plasma jet), the invention implements means for ensuring the penetration and longest path of the material to be treated in the plasma medium.

The injection of the material is performed in a zone where it tends to be homogenized with the plasma medium (it is the mixture of plasma and material to be treated that is to be homogenized). This injection is performed, with respect to the plasma jet, so as to penetrate the plasma flow or flows (in the case of a plurality of torches).

For example, the entire flow of material to be treated is injected “at the level of” the plasma jet(s).

Moreover, one or more injection trajectories, at the outlet of the injector (or injectors), can be linear or in a vortex (or a combination of the two), so as to control the residence time of the material.

A process for injecting the material, according to the invention, is therefore fundamentally different from the processes described in the prior art and in particular that described in patent GB 2160219.

The mixing or gasification chamber is preferably spherical or ovoid, in order, as explained above, to achieve an effective homogenization of the plasma and the material to be treated in this chamber and minimize thermal losses.

This shape allows for homogenization that is clearly better than that obtained with a cylindrical shape.

By comparison with the structures of the prior art, the device according to the invention optimizes the plasma reaction medium and reduces the residence time necessary for converting the carbon charge. Thus, the losses at the walls can be made acceptable in the mixing zone insofar as the reactivity of the plasma jet (where the local temperature level is very high, with the presence of dissociated or ionized molecules) is best used for the conversion. At the technological level, the device according to the invention proposes a reaction zone with a reduced size and amount of refractory material with respect to the devices of the prior art.

One of the other benefits of the device of the present invention lies in the fact that the volume of residue generated by the device is either equivalent or lower than that generated by the devices described in the prior art. Furthermore, the residue is inerted due to its in situ vitrification, which therefore enables a secondary use or a less expensive disposal.

This invention also proposes a combination of two main subassemblies, a mixing subassembly or means (also ensuring, in part, a pretreatment of the charge or, at least, the preheating thereof) and a reaction subassembly or means.

The mixing means comprise means for positioning means for injecting a flow of material and for positioning at least one plasma source in order to form at least one plasma jet, and form a homogeneous mixing zone of a flow of said material and at least one plasma jet.

Means, arranged downstream of the mixing zone, in a direction of flow of said mixture, form a reaction zone of the mixture of said material and the plasma.

Thus, the reactor is composed of a mixing chamber and a reaction zone or chamber. In operation, the plasma occupies a large part of the volume of the mixing chamber and the mixture of plasma/hot gases/hot particles, during the conversion, travels into the reaction zone confined so as to prevent the appearance of tight temperature gradients that might cause the formation of undesirable species such as methane or tars.

According to a particular embodiment, means make it possible to sense or monitor the temperature in the reaction zone, and this measurement of the temperature can be used to control, in the mixing zone, the injection of a product in order to form a protection layer for the internal wall of the mixing zone and the reaction zone according to the temperature in the reaction zone.

The invention also relates to a device for gasification, by a thermal plasma, of material in order to generate a high-quality synthetic gas, comprising:
a chamber for mixing a plasma and material to be treated, comprising openings for positioning means for injecting a flow of said material and for positioning at least one plasma source, and forming a zone for mixing a flow of said material and at least one plasma jet,
a zone for reaction, of a mixture of said material and the plasma, in communication with an opening of the chamber and extending axially from this opening,
means for measuring a temperature in the reaction zone,
means for controlling, in the mixing zone, the injection of at least one product making it possible to form a protection layer for the internal wall of the mixing zone and the reaction zone according to the temperature measured in the reaction zone.

The invention makes it possible to produce a device minimizing or avoiding the use of conventional and expensive refractory materials for the walls of he mixing zone and the reaction zone. Indeed, the formation of a suitable and controlled protection layer makes it possible to reduce heat losses at the wall and wall corrosion phenomena without using specific refractory materials.

The reaction zone preferably has a shape and a volume giving the charge to be treated a sufficient residence time in order to carry out the chemical reactions. This reaction zone also takes into account the increase in the gas flow resulting from these conversions. The mixing zone and the reaction zone are preferably objects of reduced sizes. A cooled wall can also guarantee very low inertia in the process, and therefore improved safety conditions.

The wall of the reaction zone and/or of the mixing zone can comprise or be constituted by a metal refractory material.

The mixing zone can comprise, as already explained, a chamber with a specific shape, in particular spherical or ovoid, particularly suitable for minimizing the volume of the mixing zone and, therefore, heat exchanges with the outside.

The outlet of the reaction zone can be equipped with means, for example a nozzle, creating a pressure release in order to fix the synthetic gases.

A device according to the invention advantageously comprises at least one or two plasma source(s), arranged so as to direct the flow of a mixture of material to be treated and plasma toward the reaction zone.

A device according to one of the embodiments above can also comprise means for supplying at least one plasma source at least partially with at least one gas resulting from the gasification operation (recycling of gases).

Means can be provided for cooling the mixing zone and/or the reaction zone.

The mixing zone and/or the reaction zone can also be coated with a material constituting a protective layer, for example a refractory material.

Means for purifying and/or cleaning the synthetic gas can be arranged at the outlet of the reaction zone.

The purification and/or cleaning means can comprise a pre-soaking zone.

These means can comprise means for capturing condensable materials.

According to an embodiment, a device for gasification of material according to the invention can comprise a first and at least one second gasification device, arranged in stages, in which at least one of these devices is a device according to the invention.

The invention also relates to a process for gasification of material comprising:
the injection of said material and at least one plasma jet into a mixing zone in which said material and the flow of said plasma jet meet and are mixed,
the formation of a reaction of said material and the plasma, then the maintenance of this reaction in a reaction zone, placed downstream of the mixing zone.

A temperature can be measured in the reaction zone. According to this temperature in the reaction zone, it is possible to control an injection, in the mixing zone, of a product in order to form a protection layer for the internal wall of the mixing and reaction zone.

The material to be treated can be at least partially solid and/or liquid and/or gaseous. It is, for example, solid biomass and/or organic waste and/or a liquid residue and/or a gas. This material can come at least partially from a pyrolysis and/or gasification treatment, for example according to the invention, or from other known types of processes.

The plasma jet(s) can be formed by at least one non-transferred arc torch.

At least one plasma torch can be supplied at least partially by at least one gas obtained from a gasification process, for example a process according to the invention.

The product for forming a protection layer for the internal wall of the mixing zone comprises, for example, an oxide or a carbide.

The reaction is initiated in the mixing zone and is promoted by the dissociation of plasma gases.

At least two plasma jets can be used, so as to direct the mixture of material and plasma toward the reaction zone.

The average temperature at the outlet of the mixing zone can be between 1000° C. and 2000° C., with local temperatures in the jet capable of being between, for example 3000 K and 8000 K. The temperature in the reaction zone is also between 1000° C. and 2000° C.

A gasification operation according to the invention can be performed with the addition of a reactant gas comprising air and/or oxygen and/or steam and/or carbon dioxide and/or methane or a combination of these different species.

Various adaptations are therefore possible with regard to the various modes of operation of a device according to the invention.

A device and a process according to the invention make it possible to double (by comparison with a conventional FICFB process) the production of hydrogen and carbon monoxide owing to an external electric power system. This technique also prevents the formation of carbon dioxide and steam associated with oxygen gasification.

The invention enables the production of a gaseous product from biomass and/or organic waste, which product has a concentration of organic pollutants (in particular tars) lower than 1 mg/Nm3, and even lower than 0.5 mg/Nm3 or 0.1 mg/Nm3. Such a level of purity enables it to be used with a view to synthesis, in particular fuel synthesis.

### BRIEF DESCRIPTION OF THE DRAWINGS

FIG. 1 shows a device according to the invention.

FIGS. 2A and 2B show alternatives of a reaction zone of a device according to the invention.

FIG. 3 shows another device according to the invention, in an asymmetrical configuration.

FIG. 4 shows another device according to the invention, in a staged configuration.

### DETAILED DESCRIPTION OF SPECIFIC EMBODIMENTS

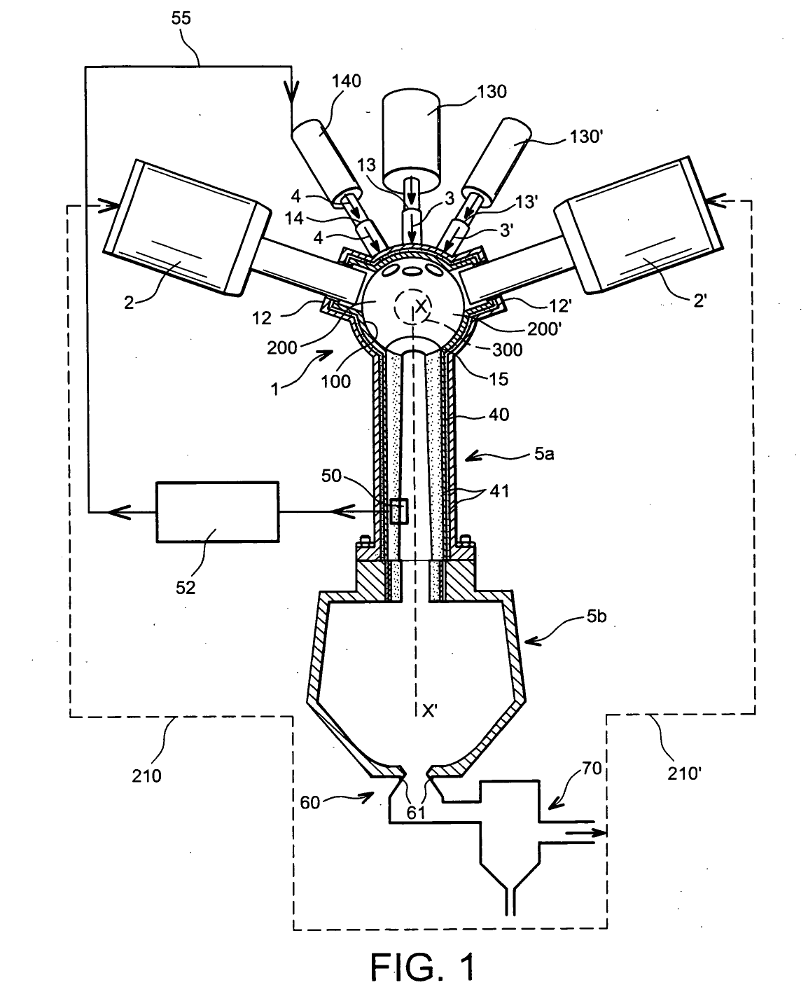

A first embodiment of the invention will be described in association with FIG. 1.

A device according to the invention comprises a first subassembly 1, or first means, forming a zone for mixing a material to be treated 3, 3′ with the flow(s) (or jets 200, 200′) of one or more plasma-generating devices 2, 2′.

The material to be treated can be solid, liquid or gaseous. It is, for example, finely divided solid biomass and/or a pyrolysis product and/or organic waste and/or a liquid residue and/or a gas. This material (in particular in the case of a gas) can, at least in part, come from, or be a by-product of, a treatment of the material to be treated. This is the case when gas is recycled to supply the plasma generators 2 and 2′ symbolized by arrows 210 and 210′ of FIG. 1. The recycling of gas can also come from a step downstream of the present process (in the case of recycling of head gases from a Fischer-Tropsch operation, for example).

Openings 13, 13′ make it possible to inject the flow of material to be treated using injection means 130, 130′. Their temperature performance and their ability to deliver a controlled flow, at a pressure suitable for the conditions imposed in the device, will be taken into account. As an example, these injection means can comprise, in the case of a liquid supply, a fogger or a straight nozzle end enabling pressurization. As another example, in the case of a solid to be converted, it is possible to use pressurized pneumatic transport means.

The injection means make it possible to produce trajectories for injection of the material to be treated, which trajectories are linear, or in a vortex, or helical, or trajectories for injection of this material resulting from a combination of linear and rotary movements.

One or more plasma torches 2, 2′ preferably with a non-transferred arc, are arranged around the chamber so as to be capable of injecting a plasma into the latter.

Such a torch operates preferably either with a gas resulting directly (after a possible treatment and/or reprocessing) from a treatment according to the present invention and/or with a gas resulting from a process downstream combined with it (recycling). It is also possible to use, optionally in combination with the previous gases, a reactant (H₂0 and/or CO₂ and/or O₂ and/or air in particular) chosen so that a satisfactory compromise is found between the various criteria for acceptability with regard to the composition of the gas generated by the present invention (H₂/CO ratio, recycled gas volume) and the profitability of the process (related in particular to the material balance and the energy balance).

In particular, as an example, the supply of at least one of the torches can be provided with a small portion of the synthetic gas flow, obtained by the treatment according to the invention (which is symbolized by arrows 210 and 210′ with dotted lines), at the outlet of the device, or by a so-called “head” gas resulting from the Fischer-Tropsch reaction (composed in particular of methane). It is also possible to choose water, in the form of steam, or directly in liquid form, according to the acceptability of the torches.

Preferably, the torch(es) 2, 2′ is (are) of the non-transferred arc type. This type of torch indeed does not require a counter-electrode outside the torch and can therefore be replaced without any intervention inside the mixing subassembly. The temperature at the level of the plasma jet is on the order of several thousand degrees Celsius (2000° C. to 3000° C. or more).

The plasma source(s) and one or more injectors can be arranged so as to direct the flow of a mixture of material to be treated and plasma toward the reaction zone.

The use of a plurality of torches makes it possible to produce greater power inside the device and/or to take advantage of the symmetry with respect to an XX′ axis of a reaction zone 5a, 5b placed downstream of the mixing zone. This reaction zone makes it possible to provide a sufficient residence time for the charge to be converted so as to achieve the desired conversion level. Such symmetry makes it possible to control the complexity of the mixing phenomena and to minimize the thermal impact of the plasma flows on the walls. It optionally makes it possible to simplify the inlet parameters leading to an optimization of the mixture of plasma gas and flow to be treated. Asymmetry of the system should not, however, be prohibited since it contributes to the homogenization of the flows.

The means 1 and the arrangement of plasma sources also make it possible to redirect the plasma flow delivered by the torch(es) so that the mixture of plasma gas and material to be treated generally follows, at the outlet of the injection subassembly, the longitudinal axis XX′ of the reaction zone 5a, 5b.

Symmetry also makes it possible to limit wear asymmetries, i.e. an unequal distribution of corrosion and/or wear phenomena on the internal walls of the zone 1 subjected to the flow of plasma gases.

To enable a continuous optimized operation, it is possible to provide a device capable of receiving a plurality of torches, and insulation means making it possible to insulate one of the inlets 12, 12′. This configuration makes possible the maintenance of a torch possible while simultaneously allowing the operation of other torches leading into the mixing subassembly 1.

The mixing zone 1 leads, downstream, into a first part 5a of the reaction zone.

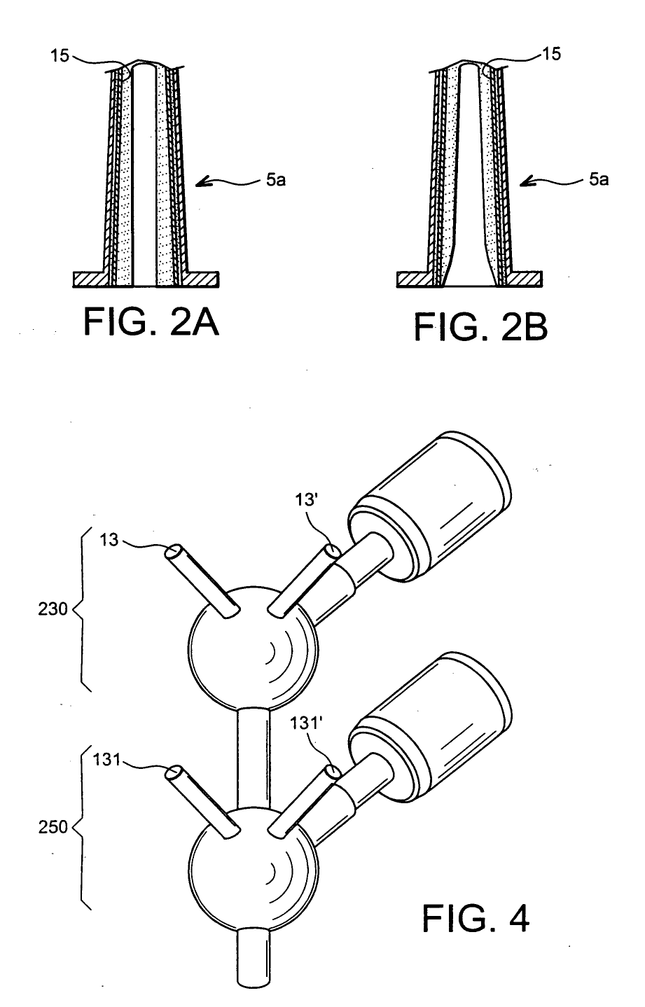

An outlet 15 of the mixing zone leads to this reaction zone 5a, which has an axis XX′ that can be, for example, that coming from the plasma flow commonly resulting from the confluence of plasma jets 200, 200′ of the torches (in case a plurality of torches are used). In other embodiments, this axis XX′ can move away from that of the device(s) for supplying the flow to be treated: this is the case in particular for the configuration using only a plasma torch, as shown for example in FIG. 2.

Means 50, for example, of the pyrometer type, make it possible to sense or measure a temperature in this reaction zone 5a.

This temperature measurement is used, for example, under control of an electronic device or a microcomputer 52 programmed for this purpose, in order to control the means 140 for injection, in the mixing zone 1, of a product 4, for example an oxide (such as, in particular, for example, MgO and/or FeO and/or CaO and/or Al2O3 and/or SiO2) in order to form a protection layer for the internal wall of the mixing zone 1 and the reaction zone 5a according to the temperature in the reaction zone 5a. The arrow 55 symbolizes this control.

This control can be used, in particular in the case of a fluctuation in the flow rate or the nature of the charge to be treated, or in the case of a lack of correspondence between the melting temperatures of the ash constituting the charge to be converted and the target temperature in the device. The adaptation of the electric power applied to the device can be another means of control.

In the absence of this injection, a natural deposit can form on the internal walls of the device, in particular in the case of charges containing ash.

A temperature reduction in this zone 5a causes an increase in the thickness of the deposit on the internal wall of the subassemblies 1 and 5a, 5b (but also 60). The deposit thus formed will cause a decrease in the heat losses at the wall. This reduction will then in turn cause a decrease in the thickness of the deposit, given that the melting temperature of the latter is fixed for the same composition.

To do away with this correlation, it may be advantageous to inject, according to the mode and control described above, a product for adjusting the melting temperature of the deposit. This deposit makes it possible to increase the insulation of the zone or of the chamber 1 and the zone 5a, 5b and prevent heat losses.

The protection layer for the internal walls of zones 1 and 5a, 5b also makes it possible to provide protection against corrosion.

The means 1 can have, as shown in FIG. 1, the shape of a chamber equipped with interfaces or openings or apertures 12, 12′, 13, 13′, 14, which shape makes it possible to confine the flow of material to be treated and one or more plasma flows 200, 200′ delivered by one or more torches 2, 2′.

The means or the chamber 1 make it possible, in order to homogenize the supply of material 3, 3′, to achieve optimal contact between the flow of material to be treated and the plasma jet(s) 200, 200′. In particular, the shape of the chamber makes it possible to provide the most intimate contact possible, in the volume of the jets 200, 200′ generated by the plasma torches, of the material 3, 3′ to be treated and/or to be converted. This intimate contact results in particular from a forced injection of the material to be treated, which is directed toward or into the plasma jet(s) 200, 200′. Thus, an injection is provided in a mixing chamber, imposing a trajectory of the material in the ionized medium generated by the torch (of which the characteristics of temperature and composition, and heat conductivity (non-homogeneous axially and radially) make it a very reactive medium).

The means 1 also make it possible to homogenize the mixture of plasma gas and material to be treated due to the turbulence generated by the flow of plasma gas (jets 200, 200′) through the suspension of material to be treated and by the confluence of the plasma jet(s) 200, 200′ with this material.

In addition, this homogenization is reinforced by an increase in the passage cross-section (between the cross-section of the torch(es)) and that of the injection subassembly) enabling the homogenization of flow speed gradients of the plasma gas.

The flow of material to be treated 3, 3′ and the flow(s) of the plasma jet(s) 200, 200′ meet in the same confluence zone 300 so that the mixture of these two flows is forced. This also results in an initiation of the reaction in the plasma chamber 1, before the mixture produced enters the reaction zone or subassembly 5a, 5b located downstream.

The kinetics of decomposition of the plasma medium can be determined or monitored by optical means. Such means make it possible, for example, to take into account the density of particles in the plasma medium.

Preferably, the chamber also makes it possible to support possible variations in the thermal flow. Such variations can appear on the internal wall of the chamber, and can be due to a possible heterogeneity and/or discontinuity in the supply of the flow of material to be treated or to a voluntary stopping of the system or to the restarting thereof. Such a voluntary stop should have relatively fast kinetics, so as to minimize the time of non-availability of the entire device (annual non-availability time preferably below 10%). Stopping of one or more plasma torches 2, 2′ can also occur, for example, in the case of a rotating maintenance on the heating systems. The chamber is therefore preferably made of a material supporting variations in the thermal flows expected on its internal surface 100. It is, for example, made of a metal refractory material, such as a cooled refractory steel. A chamber made of a conventional refractory material, such as brick or concrete, would have an excessively high production cost (due to the need for periodic replacement) and an excessively high thermal inertia, and it would not be possible to stop or restart the system quickly.

The chamber 1 can be equipped with cooling means. These means are preferably arranged around the chamber. They comprise, for example, a double casing 40 with circulation of a cooling fluid 41, for example, pressurized water.

As described below, these cooling means can also be used to cool the reaction zone, and in particular the part 5a of this zone.

As necessary, this structure can advantageously be sheathed with a complementary refractory material (for example, silicon carbide SiC) but with a limited thickness due to the presence, when the system is operating, of a deposit protecting the wall. This complementary sheath makes it possible to absorb any substantial and sudden thermal variations.

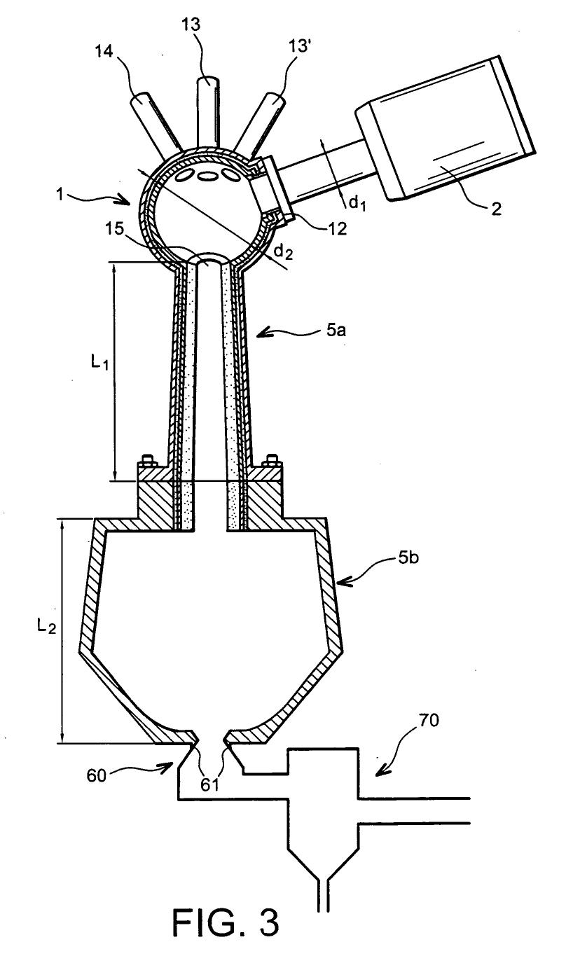

The surface of exchange between the interior of the chamber and the surrounding atmosphere, the surface at which the heat loss is proportional, is preferably as small as possible or at least chosen so that the heat losses of the device (including the losses at the level of the chamber 1) are no more than 15% (and even 10%) of the power injected. A spherical shape (in the case of FIG. 1) or an ovoid shape is optimal from this perspective. As indicated below, in association with FIG. 3, the diameter or the maximum dimension of this sphere or this ovoid shape can be, for example, on the order of several hundreds of mm, for example between 200 mm and 400 mm or 500 mm for a power on the order of several megawatts.

This invention can operate under pressure. This makes it possible to reduce the volume of the chamber 1 (such a volume attainable or compatible with an industrial use can be calculated on the basis of the diameter indications provided above), and therefore its heat losses, but also to spare a possible compression step in the case of a combination with a process downstream implementing a pressurized synthetic gas (for example, for a Fischer-Tropsch synthesis process operating at a pressure of around 30 bars).

The supply means are preferably implanted on the various injection apertures 12, 12′, 13, 13′, 14 of the chamber so that the angle of incidence of the flow to be treated with the plasma flow delivered by the torch (or the general flow resulting from the use of a plurality of torches) can maximize the performance of the subassembly. In particular, as an example, a possible configuration is shown in FIG. 1: the supply devices and the torches are located in the same plane and the angles between supply systems and torches are all around 30°.

The opening 14, which also leads into the mixing subassembly 1, makes it possible to position the means 140 enabling a compound (or a mixture of compounds) to be incorporated with the charge to be treated, which compound has physicochemical properties ensuring the formation of a protective film (or layer) on the internal wall or the injection subassembly, and on the internal wall of the reaction subassembly (part 5a and/or 5b). These means 40 can be controlled, as explained above, with a feedback control directive based on the temperature of the subassembly or of the reaction medium 5a. This addition of such a compound is particularly suitable for the case in which the characteristics of the charge do not enable it to be treated under satisfactory conditions, for example insofar as the ash constituting the flow to be treated does not have a melting temperature close enough to that which must be used in the gasification reactor.

The reaction means 5a, 5b or the reaction zone are directly adjacent to the mixing zone 1. The outlet 15 of the latter zone ends directly at the inlet of said reaction zone 5a as indicated in FIG. 1.

As explained above, the reaction can already be initiated in the zone 1. But the essential part of the reaction between the material and the plasma takes place in this second zone 5a, 5b where the material remains for a longer time than in the same zone 1. In other words, this zone makes it possible primarily to improve the conversion of the flow to be treated, which is started in the mixing subassembly 1. To do this, a second reaction volume 5b, preferably significantly larger than that of the first reaction zone 5a (for example on the order of 10ⁿ times larger, with n being greater than or equal to 1) can be attached to the first volume 5a. This second volume makes it possible to extend the reaction zone and therefore the desired residence time.

Depending on the nature of the flow of material to be treated or converted, this reaction subassembly or this reaction zone 5a, 5b can have a plurality of shapes. It can, for example, comprise:
a pressure flow reactor,
or an autocrucible reactor,
or a cyclone reactor.

Preferably, the fewest possible traditional refractory materials are used for this reaction subassembly, and preferably a metal refractory material. This reaction zone can be cooled so as to enable the formation of residue deposits from the treatment of the charge to be treated and preserve the protected metal refractory material. A solid crust or layer resulting from these deposits forms a heat protection and also a corrosion protection thickness. The cooling can be achieved with the double casing 40, 41 and the circulation of fluid 42, as mentioned above for the zone 1.

It is interesting to note that the cooling of the reaction zone 5a, 5b should in principle lead to significant heat losses. In fact, the cooling acts first as means for forming, from fluxes of the material to be treated, a protection layer or crust that, as indicated above, provides both heat insulation and corrosion protection.

This mechanism substantially limits the use of refractory materials of which the quantity would be greater without the use of this deposit phenomenon.

The part 5a of the reaction zone can have a divergent shape, as shown in FIGS. 2A and 2B. The divergent part makes it possible to take into account the increase in volume of gases produced in the conversion of the charge to be treated.

Optionally, soaking means make it possible, according to the objective and the nature of the flow to be treated, to purify the synthetic gas of its inorganic fraction and to fix its composition. These soaking means or sub-system 60 are located upstream of elements 70 complementary to the present invention, enabling the purification and/or the cleaning of the gas generated by the device of the present invention.

The means 60 comprise, for example, a divergent nozzle-type element 61 or a specific “quench” system (such as the one described in U.S. Pat. No. 6,613,127), which may or may not incorporate a fogging system so as to capture the condensable materials (in particular ash). An inertial separator 70 enables the purification and/or cleaning of the gas generated.

An alternative of the invention, in a simplified asymmetric configuration, with a torch, is shown in FIG. 3. References identical to those of FIG. 1 are used to designate elements identical or similar to those of said FIG. 1. In this FIG. 3, the other elements (means 130, 130′ for supplying the material to be treated, means 140 for supplying compounds making it possible to form a protective film, loop 210, 210′, temperature measuring means 50, feedback loop 55, etc.) of FIG. 1 are not shown, but are part of this embodiment.

The sizes indicated in this figure are provided below as an indication for a generated power on the order of 500 kW:
d₁ is between 150 and 200 mm,
d₂ is between 300 and 400 mm,
L₁ is between 500 and 3000 mm,
L₂ is between 1000 and 5000 mm.

The volumetric flow rate of the torch is preferably as low as possible (still to ensure a sufficient heating power while limiting the use of a large amount of gas). As an indication, this flow rate can be, for example, on the order of a target value below 100 Nm3/h. As already indicated above, this flow rate can advantageously be constituted by the gas produced by the device (recycling).

For this power, the device is capable of converting biomass flow rates (standardized on a dry basis) on the order of 200 kg/h.

For a torch power of several MW, for example greater than 2 MW or 5 MW or even 10 MW, it is possible to treat several tons of material per hour, for example 5 tons/hour or more, for example 10 tons per hour or even more. The size of the device is adjusted on the basis of the indications provided above.

For the post-treatment of gases resulting from a first conventional gasification stage (conventional FICFB autothermal process), the power to be applied is on the order of 1 MW per ton of gas to be treated.

As an indication, the average temperature in the functional subassembly can be around 1300° C. to 1500° C. for a plasma jet with a temperature around 5000 K to 7000 K.

The size of a symmetrical device with two torches, as shown in FIG. 1, can, by way of indication, be on the order of those mentioned for the asymmetric version (FIG. 3). The number of torches influences primarily the power generated by the device, insofar as, in this case, a single additional torch equips the mixing subassembly. More generally, the number of torches can be adapted to the requirements of the processes (power to be developed, bulk management and maintenance, etc.). For a number of torches greater than for the cases mentioned in the embodiment examples, the orders of magnitude of the aforementioned systems are to be recalculated by taking into account in particular the unit power of the torches and the mass and thermal flow constraints.

Other alternatives and configurations are possible. For example, it is possible to advantageously produce, according to specific constraints related to the process, single- or multi-torch stacks, with single or multi-staged supplies, with two or three or more than three stages.

FIG. 4 shows a single-torch assembly with a multi-staged supply.

This assembly in fact comprises two stages 230, 250 each produced according to one of the embodiments of this invention. It is also possible to have a device comprising a stage according to the prior art and, downstream, a stage according to the present invention. Such an assembly makes it possible to increase the treatment capacity of the material to be treated. In addition, the second stage 250 makes it possible to finalize a conversion or treatment that would not have been done by the first stage 230. Each stage comprises openings 13, 13′, 131, 131′ of material to be treated. The other elements of FIG. 1 or 3 are not shown in this FIG. 4, but each stage 230, 250 can have the configuration of FIG. 1 or 3.

Moreover, the number of torches per mixing subassembly is only limited primarily by the bulk thereof at the level of the subassembly, thus making it possible to achieve relatively high powers. As an indication, it is possible to use torches each having a power of around 2 MW or more (for example on the order of 10 or 15 MW).

The invention makes it possible to convert biomass and/or organic waste under high-temperature conditions (for example between 1200° C. and 1500° C. averaged at the core of the device or of the gasification zone 5) so as to minimize the deviations with respect to the thermodynamic equilibrium. The conversion is performed with a gasification agent (also called reactant), introduced through the openings 3 and/or 3′ and/or 4 or introduced as a plasma gas by the torches 2, 2′. This agent can be air, oxygen, steam, carbon dioxide or a combination of these different species, preferably in proportions making it possible to provide a generally reducing atmosphere in the gasification device.

It is possible to estimate the benefit of an allothermal process according to the invention, with respect to the conventional autothermal process, in the particular case of gasification of biomass for the purpose of producing synthetic fuel via the Fischer-Tropsch process. Two allothermal configurations can be considered depending on whether hydrogen is added (so as to adjust the H2/CO molar ratio) at the level of the device, downstream.

Table I indicates the material yields obtained (ratio of the diesel fuel mass over the dry biomass necessary in order to produce this fuel) according to the conversion processes used.

It compares the material balance (petroleum equivalent produced with respect to the amount of dry biomass used in the process) in terms of the order of magnitude for various biomass gasification process configurations. This table shows the benefit provided by the allothermal process according to the invention.

The various processes [1] to [4] used for the comparisons and mentioned in table I are as follows:

[1]: FICFB or Choren process,

[2]: process [1] completed by a post-treatment stage according to the present invention, working with the gas generated in the first step,

[3]: process according to the present invention and in which the input is obtained directly from the biomass,

[4]: process [3] in which a complementary hydrogen flow is introduced in order to optimize the amount of H2+CO for an H2/CO molar ratio of around 2.

The values of table I are provided (for the case [3] of table I on the basis of an average requirement of a third of the LHV (lower heating value, for example 15 to 20 MJ/kg) of the biomass for the gasification reactor in CO and H2, in which this energy comes from the biomass itself (which correspondingly compromises the material yield) or from an external source (allothermal process). To be capable of performing a fuel synthesis, the H2/CO molar ratio is around 2, which causes an adjustment by “gas-shift” or the supply of hydrogen from outside the initial system.

TABLE I

| | | Direct allothermal | Allothermal process |
|---|---|---|---|
| Conventional | Staged | process, | [symbol] ccording to the |
| autothermal | allothermal | according to the | invention, with the |
| process [1] | process [2] | invention [3] | addition of hydrogen [4] |
| 15% | 20% | 30% | 45% |

[symbol]

indicates data missing or illegible when filed

The invention makes it possible to produce a gaseous product having a concentration of organic pollutants (in particular tars) below 1 mg/Nm3, and even below 0.5 mg/Nm3 or 0.1 mg/Nm3. This last purity level enables it to be used with a view to synthesis, in particular the synthesis of fuel or methanol.

Finally, this invention makes it possible to work at high temperature, which prevents the formation of dioxins, in particular in the case of waste treatment.

A device according to the invention makes it possible to work with very few refractory materials, but with few losses (less than 20% or 15% or 10%).

The invention makes it possible in particular to produce a high-quality synthetic gas, comprising very few impurities, and rich in hydrogen and carbon monoxide.

1. Device for gasification, by a thermal plasma, of material in order to generate a high-quality synthetic gas, characterized in that it comprises:
a chamber for mixing a plasma and material to be treated, comprising openings for positioning means for injecting a flow of said material and for positioning at least one plasma source, and forming a zone for a homogenous mixture of a flow of said material and at least one plasma jet
a zone for reaction, of a mixture of said material and the plasma, in communication with an opening of the chamber and extending axially.

2. Device according to claim 1, further comprising:
means for measuring a temperature in the reaction zone,
means for controlling, in the mixing zone, the injection of at least one product making it possible to form a protection layer for the internal wall of the mixing zone and the reaction zone according to the temperature measured in the reaction zone.

3. Device according to claim 1, said reaction zone having a shape making it possible to control the pressure and the temperature of a mixture of material and plasma flowing from the mixing zone.

4. Device according to claim 1, said reaction zone being equipped at the output with means creating a pressure release in order to fix the synthetic gas.

5. Device according to claim 4, said fixing means comprising a pre-soaking zone.

6. Device according to claim 1, the internal wall of the reaction zone being made of a refractory metal material advantageously coated with a protection layer.

7. Device according to claim 1, the internal wall of the mixing zone being made of a metal refractory material coated with a protection layer.

8. Device according to claim 1, the mixing zone comprising a chamber having a spherical or ovoid shape.

9. Device according to claim 1, further comprising means for injecting the material to be treated, making it possible to form injection trajectories of the material to be treated, which are linear, or in a vortex, or helical or material injection trajectories resulting from a combination of linear and rotary movements.

10. Device according to claim 1, further comprising at least one plasma source.

11. Device according to claim 10, said at least one of the plasma sources having a non-transferred or a transferred arc.

12. Device according to claim 10, comprising at least two plasma sources, arranged so as to direct the flow of a mixture of material to be treated and plasma toward the reaction zone.

13. Device according to claim 10, further comprising one or more plasma sources and one or more injectors respectively arranged so as to direct the flow of a mixture of material to be treated and plasma toward the reaction zone.

14. Device according to claim 1, further comprising means for supplying at least one plasma source at least partially with at least one gas resulting from the gasification operation.

15. Device according to claim 1, further comprising cooling means for cooling the mixing zone and/or the reaction zone.

16. Device according to claim 1, the mixing zone and/or the reaction zone being sheathed with a refractory material.

17. Device according to claim 1, further comprising means to purify and/or clean or separate organic and inorganic phases at the outlet of the reaction zone.

18. Device according to claim 17, said means to purify and/or clean or separate comprising means capturing condensable materials.

19. Device for gasification of material, comprising a first and at least one second gasification device, arranged in stages, in which at least one of these devices is a device according to claim 1.

20. Process for gasification of material comprising:
the injection of said material and at least one plasma jet into a mixing zone in which said material and the flow of said plasma jet meet and are mixed homogeneously,
the initiation of a reaction of said material and the plasma, then the actual maintenance of this reaction in a reaction zone, placed downstream of the mixing zone.

21. Process according to claim 20, further comprising:
the measurement of a temperature in the reaction zone,
the control of an injection, in the mixing zone, of a product in order to form a protection layer for the internal wall of the mixing zone according to the temperature in the reaction zone.

22. Process according to claim 21, the material to be treated being at least partially solid and/or liquid and/or gaseous.

23. Process according to claim 20, said material to be treated being solid biomass and/or organic waste and/or a liquid residue and/or a gas.

24. Process according to claim 20, said material coming at least partially from a treatment of a material to be treated.

25. Process according to claim 20, said plasma jet being formed by at least one non-transferred arc torch.

26. Process according to claim 20, said plasma jet being formed by at least one plasma torch supplied at least partially or entirely by at least one gas obtained from a gasification process according to which:
the injection of said material and at least one plasma jet into a mixing zone in which said material and the flow of said plasma jet meet and are mixed homogeneously,
the initiation of a reaction of said material and the plasma, then the actual maintenance of this reaction in a reaction zone, placed downstream of the mixing zone.

27. Process according to claim 20, the product for forming a protection layer for the internal wall of the mixing zone comprises an oxide.

28. Process according to claim 20, the reaction zone being initiated in the mixing zone.

29. Process according to claim 20, comprising the injection of at least two plasma jets, so as to direct the mixture of material and plasma toward the reaction zone.

30. Process according to claim 20, the temperature in the mixing zone being between 1000° C. and 2000° C.

31. Process according to claim 20, the temperature in the reaction zone being between 1000° C. and 2000° C.

32. Process according to claim 20, the gasification operation being performed with a reactant comprising air and/or oxygen and/or steam and/or carbon dioxide or a combination of these different species.
